(19) United States
(12) Patent Application Publication
(10) Pub. No.: US 2009/0026056 A1
(43) Pub. Date: Jan. 29, 2009

(54) Switches in textile structures

(76) Inventors: Tilak Dias, Stockport (GB); William Hurley, Stockport (GB); Ravindra Wijesiriwardana, Manchester (GB)

Correspondence Address: MCDERMOTT, WILL & EMERY LLP;Attn: IP Department, 227 WEST MONROE STREET, SUITE 4400, CHICAGO, IL, 60606-5096, US

(21) Appl. No.: 11/666,380

(22) PCT Filed: Oct. 29, 2004
(86) PCT No.: PCT/GB04/04608

§ 371 Date: Feb. 19, 2008

(51) Int. Cl. H01H 3/00; D04B 1/24; D04B 1/22

(52) U.S. Cl. 200/52 R; 66/171; 66/170

(57) ABSTRACT

An electronic switch comprises electrodes (6) incorporated in a textile structure (4). The electrodes form contact faces exposed at the surface of the structure, and available for engagement simultaneously by a body part such as a finger (10). The electrical conductivity at the surface of the body part completes an electrical connection between the electrodes (6), which can complete an electrical circuit to generate an output signal. The output signal can be used to activate a number of functions.

This invention relates to the use of textile structures in electrical circuitry, particularly, it relates to the incorporation of electrodes in textile structures for switching purposes.

Electronic sensing devices have been fitted to and within textile products. Fabric based sensors, including knitted sensors, are disclosed in International Patent Publication Nos: WO 02/40091 and WO 03/094717. Reference is also directed to International Patent Application No: PCT/GB04/002191 which discloses knitted structures having at least one transduction zone comprising conducting conductive fibres. Deformation of the structure varies an electrical property of the transduction zone which can be sensed.

The present invention is directed at a switch incorporated in a textile structure operable by the simultaneous engagement of two electrodes by a body part, which engagement makes an electrical connection between the two electrodes. More particularly, a switch according to the invention comprises first and second electrodes incorporated in a textile structure, and forming contact faces on the surface of the structure. The contact faces are spaced from one another and exposed at the surface. If both contact faces are engaged simultaneously by a body part, such as a finger, the electrical conductivity at the surface of the body part completes an electrical connection between the electrodes. This connection can complete an electrical circuit to generate an output signal. The output signal can of course be used to activate any number of functions.

The textile structure in a switch according to the invention can be a woven or non-woven fabric, and in preferred embodiments is knitted. The electrodes can be formed separately at the surface, but preferably comprise conductive yarns forming part of the structure. Such yarns may comprise a conductive component bonded with a non-conductive core such as polyester or nylon. Examples of conductive components are silver and copper sulphide.

In preferred embodiments of the invention, both the first and second electrodes are connected respectively to a source of electrical power with the second electrode being maintained at a voltage greater than that at the first electrode. When the electrodes are connected as a consequence of engagement by a body part, the voltage at the first electrode is increased. The switch will be calibrated such that the voltage at the first electrode increases beyond a threshold level to generate an output signal. The two electrodes will normally be connected to the same power source, with a resistor between the source and the first electrode to maintain the first voltage at a level lower than the second voltage. The power source can be connected to the second electrode, and the resistor can be embodied in the textile structure between the electrodes.

In embodiments of the invention where the switch generates an output signal as a consequence of increased voltage at the first electrode, the first electrode can be connected to the input terminal of an amplifier with the increased voltage at the first electrode generating a proportionally increased output from the amplifier to generate the output signal. Where there is a positive (but lesser) voltage applied to the first electrode itself, means must be provided to distinguish between the basic output from the amplifier, and the increased output triggered by the electrodes being connected. This may be accomplished by connecting the amplifier output to, a debounce switch which is calibrated to effectively ignore the output from the amplifier generated by the basic voltage applied to the first electrode, and generate an output signal only when amplifier goes to positive saturation when the voltage at the first electrode is increased beyond a threshold level as a consequence of the connection being made between the electrodes by the engagement of the body part. This triggers the debounce switch which holds its output positive until the body part is removed and the connection broken.

Electronic switches according to the invention will normally be incorporated in a textile structure in such a manner that the location of one or both electrodes is clearly identified at the surface. Identification can be by colour, shape, pattern or any combination thereof, and of course a number of switches may be incorporated in the same structure. The structure might be a garment or part of a garment, a lining or wall covering, a floor covering or even a loose structure or fabric. The switch or switches may be connected to one or more functional electronic or electrical devices along conductive paths in the structure as described in the prior art, and particularly in the patent specifications referred to above. Fitted to a garment, a switch or battery of switches according to the invention can be used to activate a transmitter to operate equipment in the home or a working environment. If fitted at a fixed or relatively fixed location, of course the operation of such equipment can be more direct. For example, such a battery of switches might be installed at an entrance to the home or an office environment to activate or de-active an alarm system. The identification of the electrodes at the surface of the textile structure can be disguised in a pattern on the surface. The electrical circuitry coupled to the switches can of course embody a variety of safety features.

By incorporating one or more switches in a textile structure, the invention provides a very simple means by which a switched circuit can be deployed and replaced. Such structures can be used in or adjacent aircraft or theatre seats for example to provide a convenient means for communication between an occupant and staff. Another application of the invention is in motor vehicles where the structure can be fitted to a door, fascia or seat portion, to provide means for operating various pieces of equipment in the vehicle. The easy replacement of such structures provides a means not only for accommodating wear and tear, but for changes in the equipment to be operated or the messages to be transmitted.

The invention will now be described by way of example, and with reference to the accompanying schematic drawings wherein:

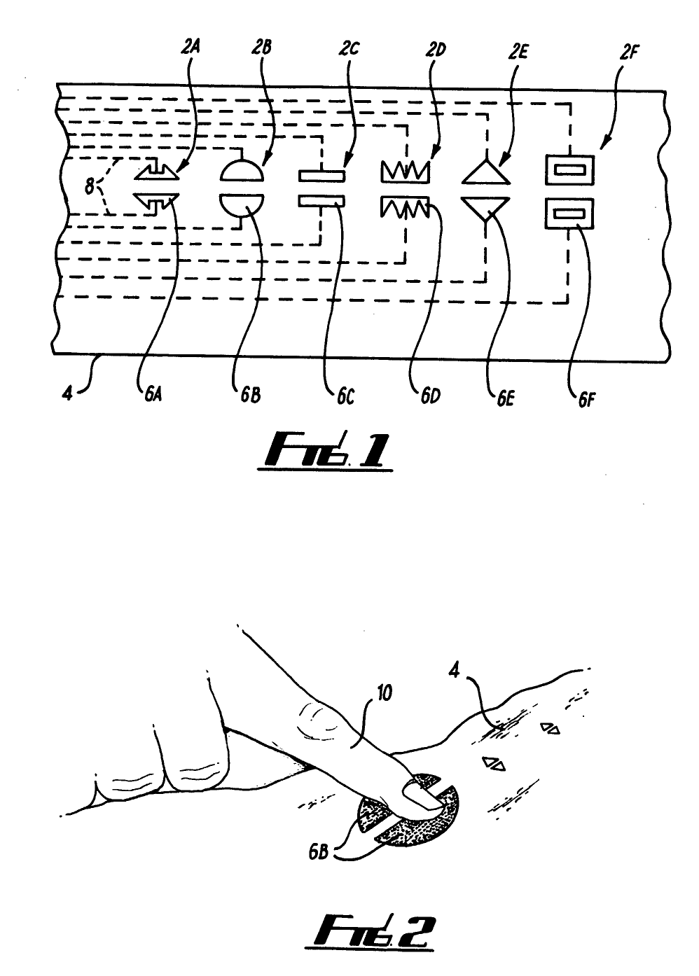

FIG. 1 is a plan view of a piece of knitted fabric incorporating a battery of switches according to the invention;

FIG. 2 is a perspective view of a switch according to the invention being activated;

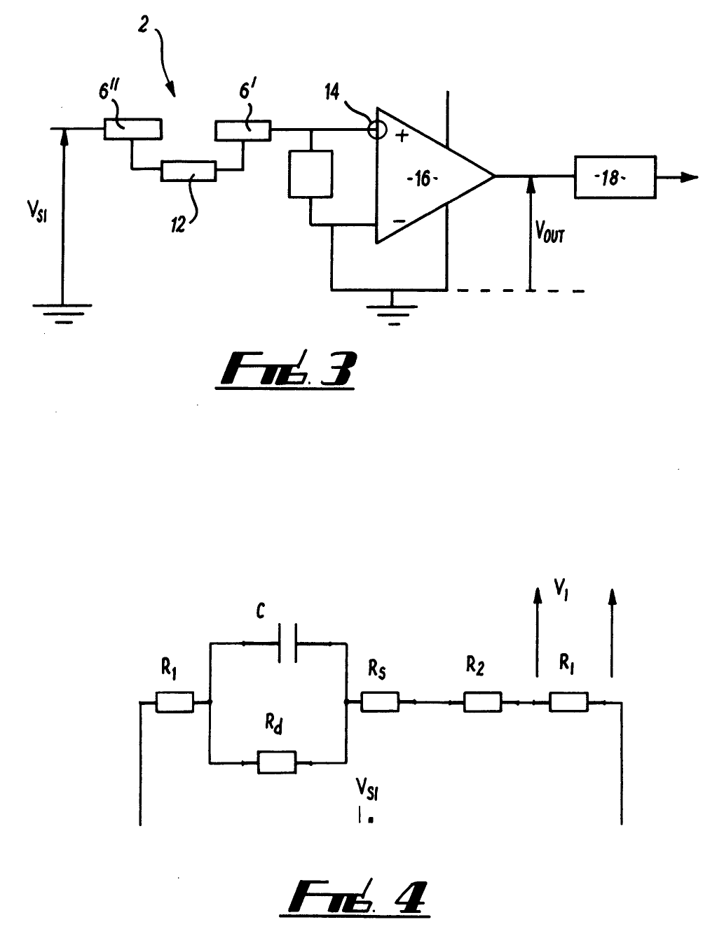

FIG. 3 shows a simple circuit comprising a switch according to the invention; and

FIG. 4 illustrates a technique for calibrating the circuit of FIG. 3.

FIG. 1 shows a battery of switches 2A-2F according to the invention incorporated in a textile structure 4. Each of the switches has a pair of electrodes 6A-6F which are shown in the figure with different shapes to give them individual identity. They might also, or alternatively, be characterised by colour or texture. The electrodes may consist of separate pads secured on the surface of the textile structure, but will preferably be part of the structure itself. Thus, the structure can be knitted, with the electrodes comprising lengths of conductive yarns at the respective surface areas indicated. The conductive yarns comprise a conductive component such as silver or copper sulphide chemically bonded with a non-conductive core such as polyester or nylon, and it is preferred that the core material is also used as the base fibre for the textile structure or fabric so as to preserve uniformity in the mechanical properties of the yarns throughout the structure. This also facilitates cleaning of the textile structure as, by using the same base structure, distortions of the structure are minimised during washing. Conductive yarns comprising polyester fibres with chemically bonded copper sulphide are particularly preferred.

The conductive yarns at the surface of the textile structure are substantially restricted to the areas of the electrodes 6 and separately connected to remote equipment (not shown) by conductors in the fabric indicated by the dotted lines 8. The incorporation of conductive yarns in textile structures, at the surface and within the body of the structure, is known from the prior specifications referred to above, to which reference is again directed.

FIG. 2 shows how a switch of the invention is activated. When a body part such as a human finger 10 is held against two electrodes 6 of a switch 2, in simultaneous engagement therewith, an electronic connection is made between the electrodes, and this can directly or indirectly generate an output signal to operate external equipment. Of course, designing circuitry in which a body part is used to complete an electrical connection has to be pursued with care to ensure that the current passing through, or on the surface of the body is at a permitted level. With this in mind it is recommended that the potential difference between the two electrodes in a switch according to the invention does not exceed one volt.

FIG. 3 illustrates an operating circuit incorporating a switch according to the invention. As shown, the switch comprises a first electrode 6′ and a second electrode 6″ connected through a resistor 12. The resistor 12 can be either deliberately installed, or represent the resistance of the textile structure between the electrodes 6. The second electrode 6″ is maintained at a voltage V_{SI} and, as a consequence of leakage through resistor 12, the first electrode 6′ is also maintained at a lower voltage. This lower voltage is coupled to the input 40 into an amplifier 16. When the switch 2 is closed by simultaneous contact of a body part with the electrodes 6, the voltage at the input 14 to the amplifier 16 increases, causing the amplifier to go to positive saturation and generating a voltage V_{OUT} at the output of the amplifier. This output is connected to a debounce switch 18 which generates an output signal in response thereto.

Under normal circumstances, the electrical resistance at the surface of human skin is much greater on the back of the hand for example than it is on the inside (at the inner finger surface) or in the palm of the hand. This is mainly due to the lower moisture content of the skin tissue. For this reason, the operating parameters in switches of the invention; applied voltage and resistance, will normally be calculated on the assumption that switches of the invention are to be activated by finger contact.

The operating voltage (V_{SI}) and resistance (R₁) of resistor 12 may be selected by using the following inequality equations 1 and 2. Equation 3 was derived by using the threshold voltage of the operational amplifier. In order to generate an output signal, the steady state voltage at the non-inverting input 14 to the amplifier must be greater than that of the threshold voltage (V_{DH}). The steady state voltage at the input 14 was obtained by using the input stage circuit shown in FIG. 4. The differential mode input impedance of the operational amplifier is assumed to be infinite.

Where R₁ and R₂ are the resistances of the resistor 12 and of the connection between the electrode 6′ and amplifier input 14, R_{d} is the epidermis resistance, C is the epidermis capacitance, and Rₛ is the terminal and the subcutaneous layer resistance for DC voltage at steady state; the input voltage V₁(S) is given by:

$${V}_{1} ( S ) = \frac{{V}_{( SI )} ( S ) {R}_{1} ( {CSR}_{d} + 1 )}{( ( {R}_{1} + {R}_{2} + {R}_{S} + {R}_{d} ) ( {CSR}_{d} + 1 ) + {R}_{d} )} \qquad Equation 1$$

at steady state for a step input of V_{SI};

$${V}_{Isteady} = \frac{{V}_{S 1} {R}_{1}}{( {R}_{1} + {R}_{2} + {R}_{s} + {R}_{1} + {R}_{d} )} \qquad Equation 2$$

therefore:

$$\frac{{V}_{S 1} {R}_{I}}{[ {R}_{1} + {R}_{2} + {R}_{s} + {R}_{I} + {R}_{d} ]} \geq {V}_{TH} \qquad Equation 3$$

The average current Iₘ(Av) and the peak current (Iₘ(Pk) have respectively to be smaller than maximum allowed values. Thus:

$$\begin{matrix}{Im}_{average} = \frac{{V}_{SI}}{( {R}_{1} + {R}_{2} + {R}_{s} + {R}_{I} + {R}_{d} )} \leq {I}_{M} \\ and \text{:} & Equation 4 \\ {Im}_{Peak} = \frac{{V}_{SI}}{( {R}_{1} + {R}_{2} + {R}_{s} + {R}_{I} )} \leq {I}_{MPeak} & Equation 5\end{matrix}$$

Also, in order to avoid switching as a consequence of contact with the back of the hand:

$$\frac{{V}_{SI} ( {R}_{I} )}{( {R}_{1} + {R}_{2} + {R}_{w} + {R}_{I} )} G \leq 0.8 V \qquad Equation 6$$

where R_{w} (normally 0.30 MΩ) is the minimum observed surface resistance on the back of the hand. R₁ and R₂ are selected to be 100 KΩ. From the above analysis and practical considerations a minimum value for V_{SI} of 15V was selected, and for R, a minimum resistance of 2.7 KΩ.

We claim:

1. An electronic switch comprising first and second electrodes incorporated in a textile structure and forming contact faces on the surface of the structure, the contact faces being spaced from one another and exposed at the surface for engagement simultaneously by a body part to make an electrical connection between the electrodes.

2. A switch according to claim 1 wherein the textile structure is knitted, and the electrodes each comprise conductive yarns in the structures.

3. A switch according to claim 2 wherein the conductive yarns comprise a conductive component chemically bonded with a non-conductive core.

4. A switch according to claim 3 wherein the non-conductive core comprises one of polyester and nylon.

5. A switch according to claim 3 wherein the conductive component is one of silver and copper sulphide.

6. A switch according to claim 1 wherein the first electrode is connected to an electrical power source to maintain it at a first voltage, and wherein the second electrode is connected to an electrical power source to maintain it at a second voltage greater than the first voltage, whereby connecting the electrodes by said engagement of a body part therewith increases the voltage at the first electrode beyond a threshold level to generate an output signal.

7. A switch according to claim 6 wherein both electrodes are connected to the same power source with a resistor between the source and the first electrode to maintaining the first voltage at a level lower than the second voltage.

8. A switch according to claim 7 wherein the power source is connected to the second electrode, and the resistor comprises the textile structure between the electrodes.

9. A switch according to claim 6 wherein the first electrode is connected to the input terminal of an amplifier, said increased voltage increasing the output from the amplifier to generate said output signal.

10. A switch according to claim 9 wherein the output from the amplifier is connected to a debounce switch which responds to the increased output voltage from the amplifier to generate said output signal.

11. A textile structure including at least one electronic switch comprising first and second electrodes incorporated in a textile structure and forming contact faces on the surface of the structure, the contact faces being spaced from one another and exposed at the surface for engagement simultaneously by a body part to make an electrical connection between the electrodes, and wherein the location of an electrode is identified on a surface of the structure.

12. A structure according to claim 11 wherein the identification is by colour.

13. A structure according to claim 11 wherein the identification is by a shaped pattern.

14. A structure according to claim 11 with a plurality of said switches.

15. A structure according to claim 14 wherein the switches are connected to plurality of functional electronic devices.

16. A garment comprising a textile structure with first and second electrodes incorporated in the textile structure and forming contact faces on the surface of the structure, the contact faces being spaced from one another and exposed at the surface for engagement simultaneously by a body part to make an electrical connection between the electrodes, and wherein the location of an electrode is identified on a surface of the structure.
